(19) United States
(12) Patent Application Publication
(10) Pub. No.: US 2026/0266274 A1
(43) Pub. Date: Sep. 10, 2026

(54) Method and Apparatus for Hydrogen Pumping and Compression

(71) Applicant: FIRSTELEMENT FUEL, INC., Irvine, CA (US)

(72) Inventors: Joshua Andrew Adams, Irvine, CA (US); Tim Brown, Irvine, CA (US); Alexander George Murashko, Jr., Irvine, CA (US)

(21) Appl. No.: 19/165,245

(22) PCT Filed: Mar. 15, 2024
(86) PCT No.: PCT/US2024/020063

§ 371 Date: Sep. 15, 2025

Related U.S. Application Data
(60) Provisional application No. 63/490,266, filed on Mar. 15, 2023.

(51) Int. Cl. F04B 25/00

(52) U.S. Cl. CPC F04B 25/00

(57) ABSTRACT

A hydrogen pumping and compression apparatus includes: a positive displacement first stage pump including a pump element disposed in a pump chamber having an inlet port and an outlet port; a first stage driver coupled to the first pump element; an inlet valve in flow communication with the inlet port of the first stage pump; a positive displacement second stage pump including a pump element disposed in a pump chamber having an inlet port and an outlet port; a second stage driver coupled to the pump element of the second stage pump; and a transfer pipe interconnecting the outlet port of the first stage pump and the inlet port of the second stage pump.

### BACKGROUND OF THE INVENTION

This invention relates generally to fuel handling and more particularly to apparatus and methods for pumping cryogenic hydrogen.

Hydrogen filling stations for vehicles typically store bulk hydrogen as a liquid at a pressure of 1-6 bar and a temperature of 18 to 25K. (Note: where not specified otherwise, stated pressures are absolute pressures. Where used, “barg” refers to gage pressure in units of bar). In order to be dispensed to hydrogen-fueled vehicles, the hydrogen must transition to a gaseous state at a high pressure of at least 350 barg, for example 900 to 950 barg and a temperature of −40 to −30 deg C (233 to 243K).

To make this transition, a sequence of pumping and warming is required. In the prior art, a two-stage process has proven effective, but the process is typically limited by the physical constraints of liquid hydrogen entering the first stage of the pumping system. Because liquid hydrogen vaporizes with only a slight input of energy or reduction of pressure such as would be experienced when throttling over a valve, a gravity feed into the first pumping stage, or subcooling stage, is employed. Furthermore, due to the constraints on minimal heat transfer into the system, the first and second pumping stages are typically connected on the same drive rod.

One problem with this type of apparatus is that the mechanical coupling of the stages causes the first stage pump to be operated at a mass flow rate exceeding the capacity of the second stage pump. This results in inefficiency due to exhaust of the excess.

### BRIEF SUMMARY

This problem is addressed by a two-stage pumping and compression apparatus, with independently operating stages.

### BRIEF DESCRIPTION OF THE DRAWINGS

The invention may be best understood by reference to the following description taken in conjunction with the accompanying drawing figures, in which:

FIG. 1 is a schematic diagram of a hydrogen filling station;

FIG. 2 is a schematic diagram of a pump and compressor apparatus;

FIG. 3 is a schematic diagram of a pump and compressor apparatus having multiple low-pressure pumps, at a first time;

FIG. 4 is a schematic diagram of the pump and compressor apparatus of FIG. 3, at a subsequent time;

FIG. 5 is a schematic diagram of the pump and compressor apparatus of FIG. 6, at a subsequent time; and

FIG. 6 is a schematic diagram of the pump and compressor apparatus of FIG. 2, configured for liquid hydrogen transfer.

### DETAILED DESCRIPTION OF THE INVENTION

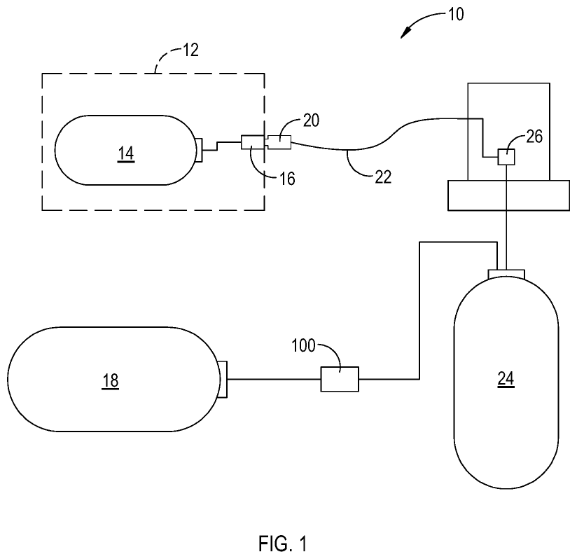

Referring to the drawings, FIG. 1 illustrates a hydrogen filling station 10 in conjunction with a vehicle 12. The vehicle 12 includes a gaseous fuel storage tank 14 equipped with a fill receptacle 16.

It is noted that the use of the vehicle 12 is merely an illustrative example, and the apparatus and method described herein are suitable for application to any cryogenic storage system.

The filling station 10 includes a bulk fuel (e.g. hydrogen) storage tank 18. In the illustrated example, bulk fuel is stored as a liquid. The fuel is ultimately dispensed in gaseous form through a nozzle 20 which is disposed at a distal end of a fill hose 22 and which is configured to be coupled to the fill receptacle 16. To permit quicker vehicle refueling, there is a ready storage tank 24 in which hydrogen is stored as a high-pressure gas.

It will be understood that a filling station 10 of this type may include conventional ancillary equipment for handling the fuel such as heat exchangers, pumps, compressors, and/or valves, and their associated controls.

The filling station 10 includes at least one control device operable to affect some aspect of the flow of gaseous fuel. One example of a control device is a controllable valve, shown schematically at 26. This could be, for example a flow metering valve.

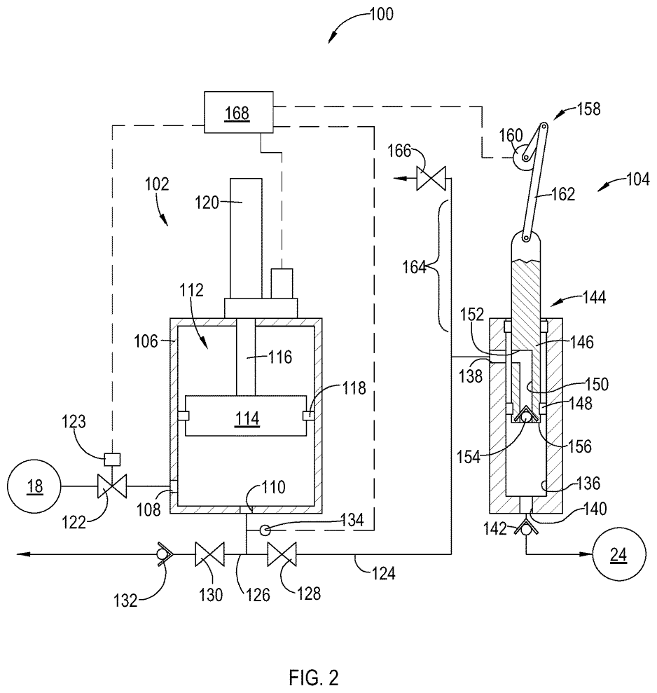

The filling station 10 includes a pumping and compression apparatus 100 for transitioning hydrogen from the bulk storage tank 18 in a liquid state at a pressure of 1-6 bar and a temperature of 18 to 25K to the ready storage tank 24 in a gaseous state at a high pressure of 350 to 950 barg and a temperature of −40 to −30 degrees C (233 to 243K), or higher. FIG. 2 illustrates an exemplary pumping and compression apparatus 100 suitable for this purpose.

It will be understood that the operating components of the apparatus 100 are interconnected along flowpaths defined by piping or tubing suitable for flowing pressurized liquid and/or gaseous hydrogen. In the drawings, piping connections are depicted by single solid lines, while data and/or control connections are depicted by single dashed lines. As used herein, the term “pipe” may refer to any conduit suitable for flowing the intended fluid, such as pipes, hoses, tubes, or manifolds; these conduits may have varying sizes and sectional shapes, and may be made up from assemblies of components such as pipe segments, couplings, and/or fittings.

The apparatus 100 includes, in series flow order, a first stage pump 102 and a second stage pump 104.

The first stage pump 102 is a positive-displacement pump with a chamber 106 having an inlet port 108 and an outlet port 110. A pump element 112 is disposed in the chamber 106 and is moveable between first and second positions, i.e., along an intake stroke and a discharge stroke. In the illustrated example, the pump element 112 includes a piston 114 coupled to a piston rod 116 and sealed to the walls of the chamber 106 with an appropriate sliding-contact seal 118. It will be understood that other types of positive-displacement chamber and pump element combinations could be substituted for the linear piston-cylinder device shown.

The pump element 112 is coupled to a first stage driver 120. The first stage driver 120 may be any mechanism suitable for moving the pump element 112 at a variable speed. Nonlimiting examples of suitable drivers include hydraulic circuits, electro-magnetic systems, or direct mechanical linkages. In the illustrated example, the first stage driver 120 is an electrically-powered ballscrew. It is noted that a ballscrew driver may be used to drive any kind of pump for cryogenic materials.

An inlet valve 122 is located at or near the inlet port 108. While various types of valve may be used, it is preferrable to use a valve which does not introduce a pressure drop in order to be held in the open position (as would be the situation with a conventional check valve). One example of such a valve is an actuator-operated valve, in which an actuator 123, such as a solenoid, operates the physical valve element inside the inlet valve 122.

A transfer pipe 124 interconnects the first and second stage pumps 102, 104. More specifically, the transfer pipe 124 is connected in flow communication with the outlet port 110 of the first stage pump 102 and the inlet port 138 of the second stage pump 104.

Optionally, the first stage pump 102 may be used to transfer (pump) liquid hydrogen from a delivery vehicle to the bulk storage tank 18, as described in more detail below. To enable this function, the transfer pipe 124 interconnecting the first and second stage pumps 102, 104 may be coupled to the outlet port 110 by a tee 126 and provided with first and second shutoff valves 128, 130 respectively, which may be manually or remotely operated, and an outlet check valve 132. Optionally, second shutoff valve 130 may be an actuated valve, such as a solenoid-operated valve. The first and second shutoff valves 128, 130 are selectively configurable to direct flow from the first stage pump 102 to the second stage pump 104 or to a bulk storage tank 18.

A pressure transducer 134 is coupled downstream of the first stage pump 102. The pressure transducer 134 is operable to sense a hydrogen pressure and generate a signal representative thereof.

The second stage pump 104 is a positive-displacement pump with a chamber 136 having inlet port 138 and an outlet port 140. A discharge check valve 142 is located at or near the outlet port 140. A pump element 144 is disposed in the chamber 136 and is moveable between first and second positions, i.e., along an intake stroke and a discharge stroke. In the illustrated example, the pump element 144 is a piston 146 sealed to the walls of the chamber 136 with appropriate sliding-contact seals 148. The piston 146 includes an internal bore 150 that extends from a transfer port 152 located on the sidewall of the piston 146, to an internal check valve 154 located at a lower end 156. It will be understood that other types of positive-displacement chamber and pump element combinations could be substituted for the linear piston-cylinder device shown.

The pump element 144 is coupled to a second stage driver 158. The second stage driver 158 may be any mechanism suitable for moving the pump element 144 at a variable speed. Nonlimiting examples of suitable drivers include hydraulic circuits, electro-magnetic systems, or direct mechanical linkages. In the illustrated example, the second stage driver 158 may be an electric motor 160 coupled to the piston 146 by a mechanical linkage 162.

The piping between the first stage pump 102 and the second stage pump 104 may incorporate a buffer volume 164. This may be selectively vented to atmosphere or to a bulk vapor storage space through a vent valve 166.

The apparatus 100 includes means for controlling the first stage driver 120 and the second stage driver 158 as well as the various valves in the system. In the illustrated example, the control means comprises an electronic controller 168. The controller 168 includes one or more processors capable of executing ladder logic, programmed instructions, or some combination thereof. For example, it may be a general-purpose microcomputer of a known type, such as a PC-based computer, or may be a custom processor, or may incorporate one or more programmable logic controllers (PLC).

The controller 168 receives inputs of hydrogen pressure from the pressure transducer 134. The controller 168 is operable to control the first stage driver 120, the second stage driver 158, and the first stage inlet valve 122 (if an actuated valve is used).

The apparatus 100 would be operated by reciprocating the first stage pump 102 by its first stage driver 120 to draw liquid hydrogen from the bulk fuel storage tank 18, as a liquid at approximately 18-25K and 1-6 bar, and discharge it as a liquid at approximately 20-30K and 2-20 bar. If an actuated inlet valve is used, then during operation, its inlet valve 122 would be command-actuated to open during the intake stroke and close during the discharge stroke. By utilizing this valving method, the liquid hydrogen will experience nearly zero pressure drop over the inlet valve 122.

At the same time, the second stage pump 104 is reciprocated by its second stage driver 158 to take the liquid hydrogen from the first stage pump 102, compress it to a gas at approximately 45-70K and at least 350 bar, for example 900 bar, and discharge it to the ready storage tank 24 of the refilling station 10.

During this operation, the first and second stage pumps 102, 104 operate independently. The second stage pump 104 may be actuated at relatively high speed to minimize the physical size while maximizing its capacity.

The first stage pump 102 may be actuated slowly, on-demand, in response to the mass flow rate of the second stage pump 104. By driving on-demand, the first stage pump 102 (alternatively referred to as a subcooling stage) does not need to pump more hydrogen than necessary. The piston 114 can be increased in diameter as required to maintain mass flow capacity. For example, the first stage pump 102 may have a swept volume of approximately 3 to 4 times the swept volume of the second stage pump 104. The resulting benefit is the ability to slowly actuate the first stage, particularly on the retraction stroke, to facilitate a smooth laminar flow feed.

Control of the first stage pump 102 may be by various methods. In one example, a pressure output target for the first stage would be specified. The controller 168 would then operate the driver 120 as required to maintain the target pressure, using feedback signals from the pressure transducer 134. For example, the driver speed could be increased to increase the pressure, or reduced (or even stopped) to lower the pressure.

Optionally, the driver 120 (or any of the other first stage drivers described herein) may be used to dynamically vary the swept volume of the first stage pump.

For example, the first stage pump could have a maximum physical swept volume much greater than that of the second stage pump, such as a ratio of 50 to 1. In operation, the driver may be actuated to move the piston a desired portion of the maximum possible stroke. In this way the real time swept volume of the first stage pump could be anywhere from 1 to 50 times that of the second stage pump.

Optionally, the buffer volume 164 (if present) may be used to absorb any differential of displacement between the first and second stage pumps 102, 104 which may result from a slight mismatch in volume flow rate. This would most likely occur during transient periods of operation, such as when changing output pressure of the second stage pump 104. This buffer volume could be vented as needed to maintain the correct pressure. This volume could also act as a catch for any gas bubbles that may be generated from the first stage pump 102.

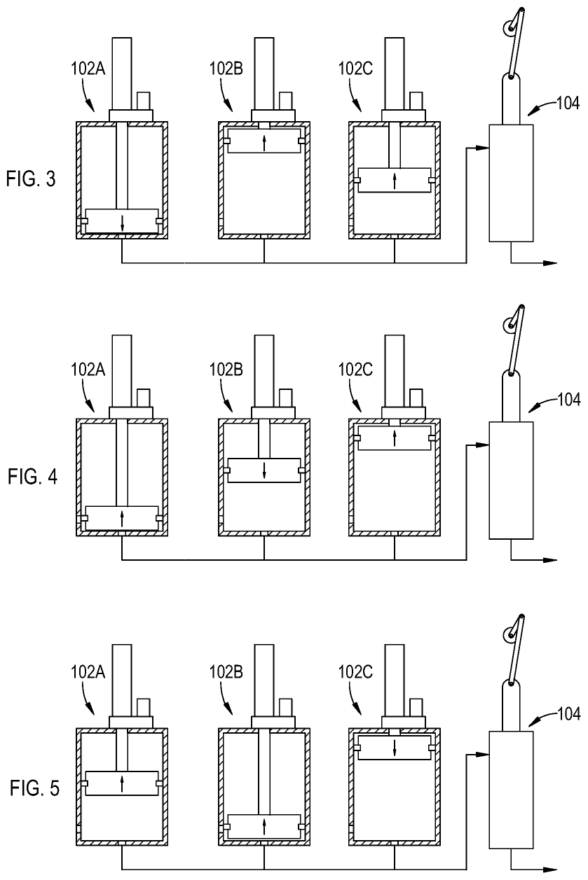

Optionally, multiple first stage pumps could be used to feed a group of one or more second stage pumps. In one example, a group of three first stage pumps would be used to drive two second stage pumps. The use of multiple first-stage pumps ensures adequate flow capacity to feed the second stage pump. In the example shown in FIGS. 3-5, three first stage pumps labeled 102A, 102B, and 102C all discharge into a common piping run, analogous to transfer pipe 124, feeding a second stage pump 104. Each of these first stage pumps 102A, 102B, and 102C is provided with its own independently-controlled driver as described above. They may be operated in a sequence that provides smooth flow output while minimizing piston speed, especially on the intake stroke.

In FIG. 3, pump 102A is shown that the end of a discharge stroke, moving downward at a baseline speed as shown by the arrow. Pump 102B is nearing the end of an intake stroke as shown by the arrow. During this intake stroke, pump 102B may operate as a reduced speed, for example half of the baseline speed. Pump 102C is near the middle of an intake stroke as shown by the arrow. During this intake stroke, pump 102C may operate at a reduced speed, for example half of the baseline speed.

FIG. 4 shows the pumps at a time after that shown in FIG. 3. Pump 102A is beginning an intake stroke, moving upward at a speed less than the baseline speed, as shown by the arrow. Pump 102B is moving downward at the baseline speed in a discharge stroke, as shown by the arrow. Pump 102C is near the end of a intake stroke as shown by the arrow. During this intake stroke, pump 102C may operate in a reduced speed, for example half of the baseline speed.

FIG. 5 shows the pumps at a time after that shown in FIG. 4. Pump 102A is partially through its intake stroke, moving upward at a speed less than the baseline speed, as shown by the arrow. Pump 102B has completed its discharge stroke and is moving back upwards in an intake stroke, as shown by the arrow. During this intake stroke, pump 102B may operate at reduced speed. Pump 102C is beginning a discharge stroke as shown by the arrow. During this discharge stroke, pump 102C may operate at the baseline speed.

This cycle may be continued, with each of the pumps alternately discharging at the baseline speed and retracting at a reduced speed. The net effect is to provide a highly uniform liquid flow rate while minimizing piston speeds.

In an alternate configuration, two or more first stage pumps as shown in FIG. 3 may be used, and independently controlled with a dynamic sequence as opposed to a static sequence. For example, if two first stage pumps are used one of them may be operated at a variable speed. This could be useful in a situation where one of the first stage pumps is nearing the end of a discharge cycle, but additional flow is required to supply the requirements of the second stage pump. In such a situation, the independent controller could be used to accelerate the discharge stroke of the other first stage pump, causing it to “catch up with” the cycle of the other first stage pump and assure that adequate flow is supplied to the second stage pump.

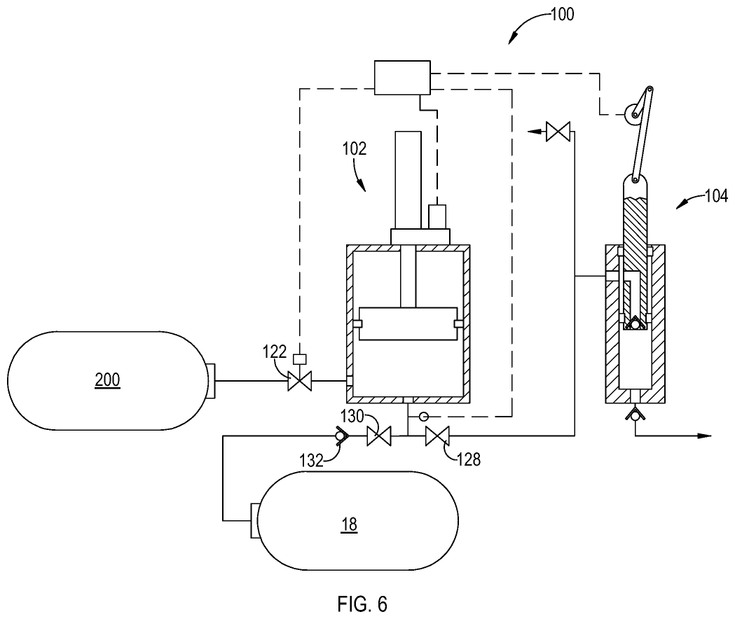

Another possible use for the apparatus 100 is truck unloading. Conventionally, hydrogen is transported to the hydrogen refueling station 10 in a transport container (shown schematically at 200 in FIG. 6). The transport container 200 could be for example a tank mounted on a truck or a rail car.

Typically, hydrogen is stored in the transport container 200 as a liquid at 18-25K and approximately 1.4 bar. In the prior art, a heat intense process called pressure building is utilized to generate pressure differential sufficient to push liquid hydrogen from the transport container 200 to the refilling station 10. During this process a substantial amount of hydrogen is vented to atmosphere to relieve the transport container pressure following the transfer. If the apparatus 100 were to be utilized for this purpose, analysis has shown that tremendous savings in lost hydrogen could be attained since the transport container pressure could remain low and the apparatus 100 would be able to transfer the liquid hydrogen at high efficiency.

Referring to FIG. 6, to enable this function, the transport container 200 would be coupled to the inlet port 108. The first shutoff valve 128 would be closed and the second shutoff valve 130 would be opened.

The first stage pump 102 would then be operated by the first stage driver 120 in a manner similar to that described above, moving the liquid hydrogen from the transport container 200 to the bulk storage tank 18, as a liquid at approximately 18-25 K and approximately 0.27-2.5 bar. The hydrogen flow path would be from the transport container 200, through the inlet valve 122, through the pump 102, the first shutoff valve 128, the outlet check valve 132, and finally into the bulk storage tank 18. The second stage pump 104 would not be used. Alternatively, in a configuration in which inlet valve 122 and second shutoff valve 130 are both actuated valves, they could be actuated cyclically in sync with the operation of the first stage pump element 112. For example, inlet valve 122 would be opened and second shutoff valve 130 closed during the intake stroke, and inlet valve 122 would be closed and second shutoff valve 130 would be opened during the discharge stroke. In this configuration, outlet check valve 132 would be eliminated. This configuration can reduce or eliminate pressure loss across valves during pump operation.

The pump configuration in FIG. 6 could optionally be used to move the liquid hydrogen from the bulk storage tank 18 directly to a vehicle (not shown) that uses the hydrogen as fuel, as a liquid at up to 16 bar pressure. To accomplish this transfer, the bulk storage tank 18 would be coupled to inlet valve 122 in FIG. 6, and the vehicle (for example vehicle 12 of FIG. 1) would be coupled to the outlet check valve 132 in FIG. 6.

This apparatus has certain advantages. A first stage pump which is subcooling hydrogen supplied from a liquid tank by pressurizing the liquid to a range of 8 to 10 barg and is able to operate slowly and on-demand will enable a more effective design of a second pumping stage for high pressure. One clear advantage will be facilitating higher operating speed of the second stage while eliminating excess pumping of the first stage. Another clear advantage would be the ability to send the discharge of the first stage to a different destination.

By incorporating independent drivers, the thermal conduction efficiency of the system may be reduced compared to a prior art pump having coupled stages, but the nature of the low pressure subcooling chamber will allow for reduced material rigidity and therefore enables very efficient thermal isolation. Notably, pump rod structural loads will be very small in the first stage pump compared to the second stage pump; accordingly, its construction can be lighter. In the same way, by eliminating the bi-directional loading of the traditional two-stage pump drive, the loading of the second stage pump 104 can be transitioned entirely to single-direction loading (i.e. either solely compression or solely tension) which allows for reconfiguration of the structure to improve thermal isolation efficiency.

The foregoing has described a hydrogen pumping and compression apparatus and method. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A hydrogen pumping and compression apparatus, comprising:
a first positive displacement first stage pump including a first pump element disposed in a first pump chamber having an inlet port and an outlet port;
a first stage driver coupled to the first pump element;
an inlet valve in flow communication with the inlet port of the first stage pump;
a positive displacement second stage pump including a second pump element disposed in a second pump chamber having an inlet port and an outlet port;
a second stage driver coupled to the second pump element; and
a transfer pipe interconnecting the outlet port of the first stage pump and the inlet port of the second stage pump.
wherein the first stage driver is configured to cause the first pump element to discharge at a first speed and to cause the first pump element to retract at a second speed in a single cycle, the first speed different from the second speed.

2. The apparatus of claim 1, wherein:
the transfer pipe communicates with a buffer volume; and
the buffer volume includes a vent valve communicating with at least one of the atmosphere and a bulk storage vapor space.

3. The apparatus of claim 1, wherein the inlet valve is actuator operated.

4. The apparatus of claim 3, further comprising an electronic controller operably connected to the first stage driver, the second stage driver, and the inlet valve.

5. The apparatus of claim 1, further comprising a pressure transducer, wherein:
the pressure transducer is operable to sense a hydrogen pressure in the transfer pipe and generate a signal representative thereof, and is operably connected to an electronic controller operably connected to the first stage driver and the second stage driver; and
the electronic controller is configured to control at least one of the first speed and the second speed using the generated signal.

6. The apparatus of claim 1 wherein a ratio of a swept volume of the first stage pump to a swept volume of the second stage pump is variable between 1:1 and 50:1, inclusive.

7. The apparatus of claim 1, further comprising:
at least one further positive displacement first stage pumps each of the at least one further first stage pump including a respective pump element disposed in a respective pump chamber having a respective inlet port and a respective outlet port,
wherein the transfer pipe interconnects the respective outlet port of the at least one further positive displacement first stage pump with the inlet port of the second stage pump.

8. The apparatus of claim 1, wherein:
a tee is connected to the transfer pipe and the outlet port of the first stage pump;
a first shutoff valve is positioned between the transfer pipe and the tee; and
a second shutoff valve is positioned between the tee and a further pipe,
wherein the first and second shutoff valves are selectively configurable to direct flow from the first stage pump to the second stage pump and/or to a storage tank or to a vehicle directly receiving liquid hydrogen as fuel.

9. A hydrogen pumping and compression method, comprising:
operating a first pump element of a first positive-displacement first stage pump using a first stage driver to draw hydrogen from a bulk fuel storage tank, as a liquid at a temperature of 18-25K and a pressure of 1-6 bar, and discharge it to a transfer pipe as a liquid at a temperature of 20-30K and a pressure of 2-20 bar, wherein the first stage driver is configured to cause the first pump element to discharge at a first speed and to cause the first pump element to retract at a second speed in a single cycle, the first speed different from the second speed; and
simultaneously, operating a second pump element of a positive-displacement second stage pump using a second stage driver which is independent of the first stage driver, to compress the liquid hydrogen from the first stage pump to a pressure of at least 350 bar, and discharge it from an outlet of the second stage pump.

10. The method of claim 9, wherein ratio of a swept volume of the first stage pump to a swept volume of the second stage pump is varied within a range of 1:1 to 50:1, inclusive, while operating the first pump element.

11. The method of claim 9, wherein:
the transfer pipe incorporates a buffer volume.

12. The method of claim 11, further comprising:
monitoring the pressure of the liquid hydrogen in the buffer volume; and
in response to the pressure exceeding a predetermined value, venting some of the liquid hydrogen to the atmosphere or to a bulk storage vapor space, through a vent valve, so as to reduce the pressure.

13. The method of claim 9, further comprising using an electronic controller to control the first stage driver and the second stage driver.

14. The method of claim 13, further comprising:
using a pressure transducer disposed downstream of the first stage pump, to sense a hydrogen pressure; and
controlling the first driver with the electronic controller to discharge at the first speed to maintain a target pressure, using feedback signals from the pressure transducer.

15. The method of claim 9, wherein two or more of the positive-displacement first stage pumps are operated, each with its own a first stage driver, to draw hydrogen from the bulk fuel storage tank, as a liquid at a temperature 18-25K and a pressure of 1-6 bar, and discharge it as a liquid at a temperature of 20-30K and a pressure of 2-20 bar.

16. (canceled)

17. (canceled)
